(19) United States
(12) Patent Application Publication
(10) Pub. No.: US 2012/0173571 A1
(43) Pub. Date: Jul. 5, 2012

(54) Engine, System and Method for Interconnection and Information Exchange Between Interested Parties in a Business Transaction

(76) Inventor: Kari Joseph Sikias, Los Angeles, CA (US)

(21) Appl. No.: 13/177,025

(22) Filed: Jul. 6, 2011

Related U.S. Application Data
(60) Provisional application No. 61/362,031, filed on Jul. 7, 2010.

(51) Int. Cl. G06F 17/30; G06F 15/16

(52) U.S. Cl. 707/769; 707/E17.045; 707/E17.014

(57) ABSTRACT

Disclosed is an engine, system and method for providing an interactive interconnection between parties in a business transaction. The engine, system and method may include requesting remote entry over at least one network of at least one profile from each of at least two users, wherein the profile comprises at least a user type, a technology type, and a transaction sought, electronically querying each of the at least two users with at least one preliminary profile question indicated by the profile, and preliminarily matching at least two of the at least two users in a transaction indicated by at least the profile and the preliminary profile questions. The present invention may further include electronically providing at least a first of the at least two users with secondary questions from the other of the at least two users, responsive to the preliminarily matching and indicated by the transaction sought, and interconnecting the at least two users in accordance with responses received to the secondary questions. Further included may be remotely fulfilling the transaction sought after the interconnecting.

### CROSS REFERENCE TO RELATED APPLICATIONS

This application claims, priority to U.S. Provisional Application Ser. No. 61/362,031, filed Jul. 7, 2010 entitled, Engine, System and Method for Interconnection and Information Exchange Between Interested Parties in a Business Transaction, the entire disclosure of which is incorporated herein as if set forth in its entirety.

### BACKGROUND

1. Field of the Invention

The present invention relates to business transactions, and, more particularly, to an engine, system and method for interconnection and information exchange between interested parties in a business transaction.

2. Description of the Background

At present, investment in small and mid-size companies is a significant driver for the world economy. In the United States alone, companies backed by venture investment account for 12 million jobs, and 21 percent of the gross domestic product. Since 1970, over $450 billion has been invested in over 27,000 U.S. start-up, small, emerging, and mid-size companies. Even in the midst of an economic downturn in the late 2000's, venture investment reached nearly $18 billion in the U.S. in 2009, and nearly $5 billion in the first quarter of 2010, from a high of over $100 billion of venture investment in 2000.

Additionally, industries have developed around the venture investment model. For example, loan alternatives, such as peer-to-peer lending, have been developed to better help match investors with prospective borrowers, and to thereby streamline the process of obtaining business loans for borrowers, while increasing a rate of return for investors. Similarly, legal websites and venture associations have developed to provide sample documents for investment, and limited information regarding prospective investors. Further, universities have begun to offer guidance, and coursework, to help professors and students develop, gain investment in, and spin out, various technologies. Finally, and perhaps most significantly, social networking sites have entered the business arena, such as LinkedIn, in an endeavor to bring contacts, such as investors and investors seeking investment, together.

However, these advances notwithstanding, finding an investor, a joint venture partner, a development partner, or a company or technology to invest in remains, in part, a matter of known contacts and connections related to known contacts, and, in large part, a matter of luck in being at the right place at the right time. Additionally, even in light of the available tools to connect parties in a transaction, certain parties, such as investors, may not wish it to be generally known that such party is interested in a transaction, lest that party be overwhelmed with information or transaction requests. Consequently, despite the available tools for all parties in a small to mid-size company transaction, a tremendous percentage of companies fail after gaining early, limited investment from friends and family, and an even greater percentage of companies never get started due to a lack of expertise in business, investment, partnering and nurturing.

Therefore, the need exists for an engine, system and method that provides the nurturing needed to facilitate transactions for start-up, small, emerging, and mid-size technologies and companies, and that eliminates the current reliance for the occurrence of such transactions on a known, limited universe of contacts and connections.

### SUMMARY OF THE INVENTION

The present invention is and includes an engine, system and method for providing an interactive interconnection between parties in a business transaction. The engine, system and method may include requesting remote entry over at least one network of at least one profile from each of at least two users, wherein the profile comprises at least a user type, a technology type, and a transaction sought, electronically querying each of the at least two users with at least one preliminary profile question indicated by the profile, and preliminarily matching at least two of the at least two users in a transaction indicated by at least the profile and the preliminary profile questions.

The present invention may further include electronically providing at least a first of the at least two users with secondary questions from the other of the at least two users, responsive to the preliminarily matching and indicated by the transaction sought, and interconnecting the at least two users in accordance with responses received to the secondary questions. Further included may be remotely fulfilling the transaction sought after the interconnecting.

Additionally, the present invention may provide documentation, and/or links to service providers. Moreover, the present invention may provide reference or educational materials to users to facilitate transactions, and the reference or educational materials may be unique to each user.

Therefore, the present invention provides an engine, system and method that provides the nurturing needed to facilitate transactions for start-up, small, emerging, and mid-size technologies and companies, and that eliminates the current reliance for the occurrence of such transactions on a known, limited universe of contacts and connections.

### BRIEF DESCRIPTION OF THE FIGURES

Understanding of the disclosure will be facilitated by consideration of the following detailed description taken in conjunction with the accompanying drawings, in which like numerals refer to like parts and wherein:

FIG. 1 is a graphical illustration of a financing cycle;

FIG. 2 depicts an exemplary interface for an interactive interconnection engine;

FIG. 3 illustrates a methodology for facilitating transactions using an interactive interconnection engine; and,

FIG. 4 illustrates a system for providing an interactive interconnection engine.

### DETAILED DESCRIPTION OF THE INVENTION

It is to be understood that the figures and descriptions have been simplified to illustrate elements that are relevant for a clear understanding, while eliminating, for the purpose of brevity, many other elements found in typical content delivery and information exchange apparatuses, systems and methods. Those of ordinary skill in the art may recognize that other elements and/or steps may be desirable and/or required in implementing the disclosure. The disclosure herein is directed to all such variations and modifications to such elements and methods known to those skilled in the art.

The present invention is and includes an interactive software engine for interconnection of interested parties in corporate creation, investment, partnering and joint venturing, and acquisition, among other business-related circumstances. The interactive engine is, in a preferred embodiment, an interactive software engine provided via one or more networks, such as via the internet, to users for remote access from one or more microprocessors and computing memory on which the software is resident and/or from which the software is executed. Such microprocessors and computing memory may be or include, for example, one or more personal computers, smart mobile devices, laptops, broadband devices, servers, network nodes, and the like. The interested parties making use of the interactive engine of the present invention may include, for example, investors, universities, local, state and federal governments, inventors, invention clearinghouses, intellectual property auctions, and the like.

The interactive engine of the present invention thereby provides a transactions marketplace for investors and inventors. The marketplace may include or be associated with one or more valuation mechanisms for valuing a business or its intellectual property, to thereby provide a baseline for a inventor's request for monies or partners. The marketplace may further include a series of permissions that allow for status indications to be associated with members in the marketplace, such as to indicate a verified or unverified status to other members of the marketplace.

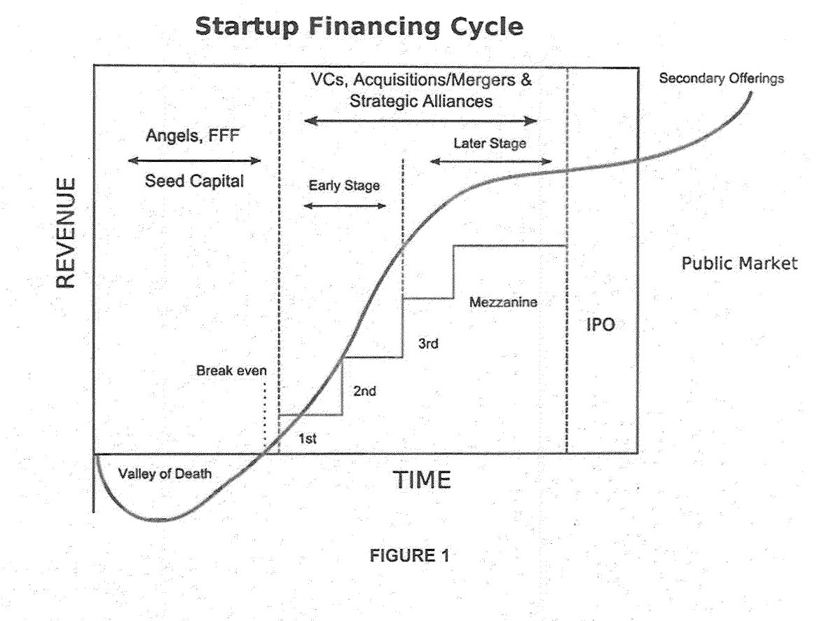

According to the National Venture Capital Association, 11% of private sector jobs come from venture backed companies, and venture backed revenue accounts for 21% of US GDP. It is arguable that a “funding gap” has developed between friends and family investments. typically in the $0 to $250,000 range, and the amounts that most Venture Capital Funds prefer to invest, which are typically between $1 to $2 M. This funding gap may be accentuated by the fact that some successful Venture Capital funds have been drawn to raise ever-larger funds, requiring them to search for correspondingly larger investment opportunities. This ‘gap’ is often filled by sweat equity, angel investors and equity investment companies, who invest in the range of $250,000 to $1 M. The National Venture Capital Association estimates that the latter now invest more than $30 billion a year in the U.S. alone. This financing cycle, facilitated by the marketplace and engine provided by the present invention, is illustrated in FIG. 1.

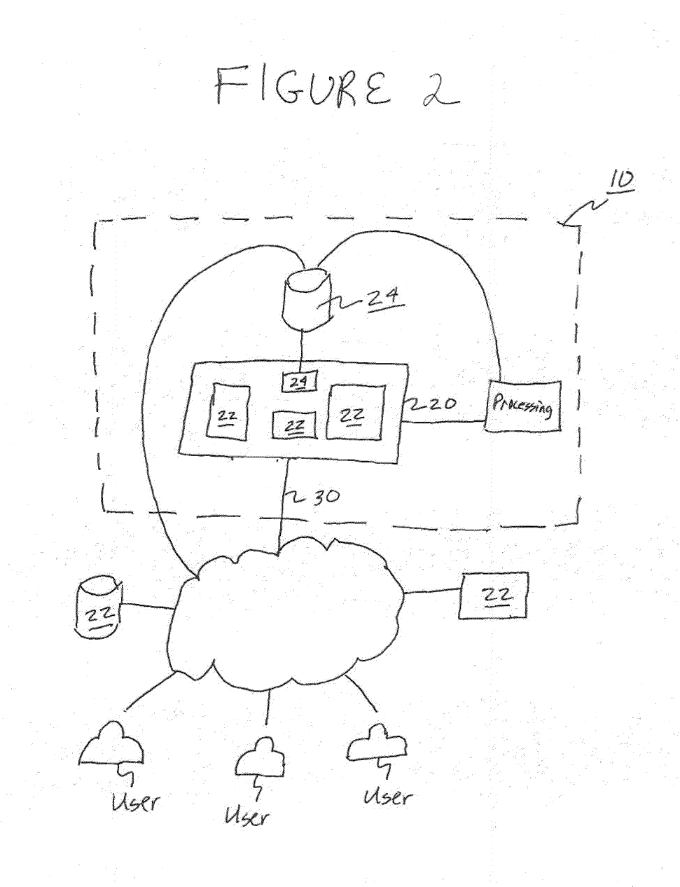

More specifically, and as particularly illustrated in FIG. 2, an interactive interconnection engine 10 provides a user interface 20 that indicates a plurality of available information 22, based on user type, wherein a user type may be indicated by at least a preliminary user profile 24. The user profile 24 may include, for example, verification of a particular user where required (such as qualification as a “qualified investor,” or verification of bank funds for a “micro-investor”), and such verification may include payment of a member fee. For example, a venture capital investor may be verified, such as a “qualified investor,” before gaining access to information of other users, such as by legal documents, an internal verification, an external verification, payment of a not insubstantial member fee to join, or the like.

The user interface 20 of FIG. 2 may be provided in various forms to one or more of personal computers, laptops, mobile devices, broadband devices, and the like, and the form may vary based on, for example, user type, bandwidth or quality of service description according to the device type. The exemplary embodiments of the present invention are set forth by way of example herein with respect to particular user and/or computing device types, although those skilled in the art will appreciate the application of the interactive engine to other embodiments, other device types and other user types not specifically set forth in the examples discussed herein.

As illustrated in FIG. 2, the interactive interconnection engine 10 provides the networked user interface 20, and consequently all or a portion of the information provided 22 may be provided via one or more network links 30. Connected, over the at least one network, to the user interface are a plurality of users comprising a plurality of different user types. The plurality of users may be categorized by, for example, user type by category and/or subcategory, user device type, typical user request type, valuation or investment level, or the like 24. Thereby, each of the users may be provided with information 22 most relevant to that user based on the user categorization, and may, at predetermined times during usage, be asked to provide information unique to that user's type, that user's category within that user type, that user's requests made of the engine 10, and the like. Further, information 22 may not only be that which is most relevant to a particular user or user type, but may additionally be that which the user is authorized to view, such as based on the user's profile, the user's verifications as discussed above, and the like.

For example, a first user type may be an “inventor.” The inventor, as defined herein, may include any type of entrepreneur and/or creator of technology. An inventor may wish to join the interactive interconnection engine of the present invention for a number of different reasons, such as the desire to find an investor, the desire to find a partner, such as a joint venture partner or research and development partner, or the inventor may seek advice, such as legal advice, articles, links, or similar teaching tools with regard to taking on investors, being acquired, obtaining government grants, entering a developmental partnership, and the like.

The inventor may, for example, be warned, based on user type, of the need for a confidentiality agreement before providing information to other users, may be provided with a form of confidentiality agreement (subject to a disclaimer that the engine 10 does not provide legal advice), and/or may be provided with a link to recommended legal counsel, as discussed further below. Likewise, the interactive engine may serve as an ad server, whereby advertising associated with particular legal, such as local legal, services, is provided to a user, such as based on the user's geography, and/or based on other factors, such as the screen of the user interface on which the user is currently parked, the type of user or other information assessed via Cookie, or the like.

Further, the exchange of confidentiality agreement executions may occur via engine 10, and other measures for the protection of information may be provided based on user type. For example, the aforementioned inventor may be provided with a link, or a deep link, to the United States Patent and Trademark Office, such as to suggest the filing of a provisional patent application. Of course, based on the user type, the inventor may not only be provided with an electronic filing link to file a provisional patent, for example, but may additionally be provided with myriad informational Jinks on how best to prepare a provisional patent application.

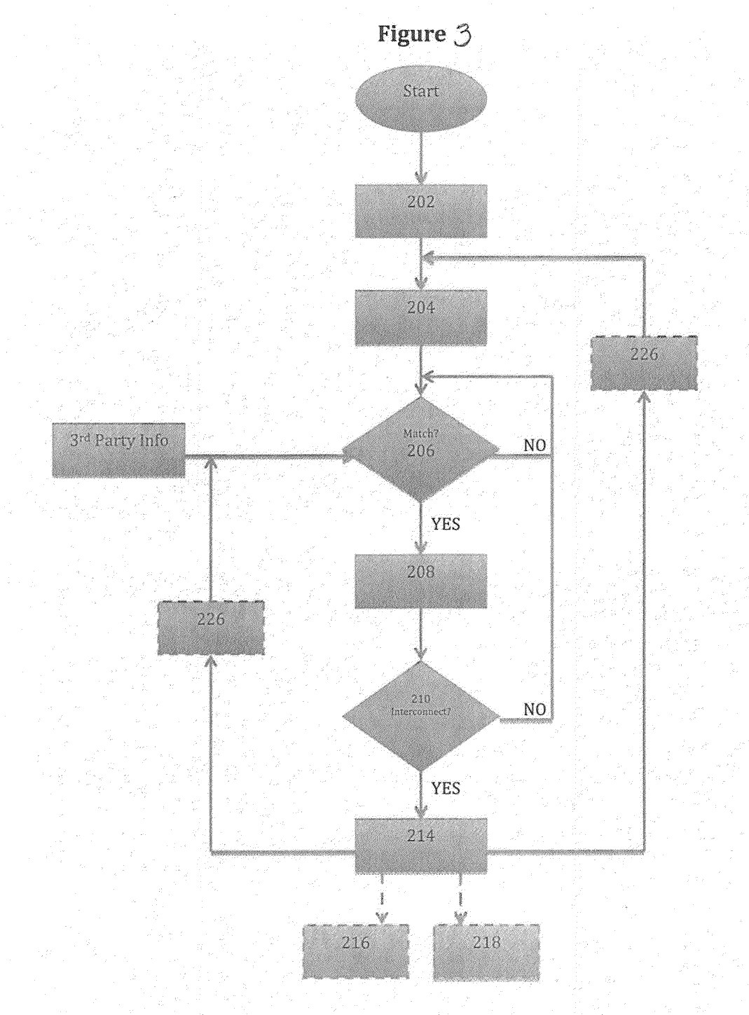

FIG. 3 is a flow diagram illustrating an exemplary method 200 employing the interactive interconnection engine of the present invention. In the exemplary method 200, a user requests to enter a profile at step 202. The profile may include, for example, a user type, a technology type, a transaction sought, necessary verifications, and the like. The profile may additionally include other information, such as a valuation of the user's company or intellectual property, as may be generated by the interactive engine, or by a third party for incorporation into the profile. Of note, The Economist has estimated that up to 75% of the value of US public companies is now based on intellectual property, and often, 100% of a small startup company's value is based on its intellectual property.

At step 204, the user may be asked one or more preliminary profile questions in accordance with the profile requested, such as to gain more detail for an inventor to allow for comparison, by investors, of that inventor to other inventors. Further, the preliminary questions may include confidentiality information, and the like, and may further include referrals, based on the preliminary questions responses. For example, venture capital investors may pay a fee, such as in accordance with a Google advertising model, to receive a priority referral to certain inventor types, and lawyers may offer discounts in exchange for volume referrals on, for example, the preparation of provisional patent applications.

At step 206, the interconnection engine may make a match based on the preliminary information entered by at least two parties seeking to be on opposite sides of the same transaction, such as a matching of inventor and investor, parties seeking a similar joint venture, prospective co-developers, or the like, for example. Parties may be matched based on any of a variety of criteria, such as may be indicated by user profile or by user participation in an electronic indication system for indicating user specifics. Such criteria may include, by way of non-limiting example, a company or intellectual property valuation, intellectual property filed for or held, technological sector of operation, funding sought, or the like. At step 208, matched parties may be provided with detailed profile questions from the other prospective party to better assess the quality of the match at step 206. Parties having high quality matches at step 208 may be interconnected at step 210, in a manner previously approved in accordance with the profile of the respective parties entered at step 202, and a transaction may be facilitated at step 214.

More particularly, interconnection at step 210 may include assurances that all parties will consummate the transaction, if the transaction is consummated, through the use of the present invention. Such assurances may include, for example, legal averrances at the time of signup at step 202, and/or just prior to receipt of the other party's contact information. Other assurances may include an equity and notification provision or provisions issued in favor of the provider of the engine of the present invention. Yet further, interconnection at step 210 may include maintenance of anonymity of the transacting parties, whereby the information exchange is made available only though the engine of the present invention.

Facilitation of a transaction at step 214 may optionally include, for example, interconnection with relevant, recommended service providers to enable the transaction, at step 216, wherein such recommendations may be gained by transaction feedback optionally provided at step 226. Additionally, facilitation at step 214 may optionally include provision of relevant document templates to enable the matched transaction at step 218. Yet further, facilitation at step 214 may optionally include local and/or linked information, provided by user type, to describe and explain aspects of the transaction respectively relevant to each user type.

As illustrated in the exemplary flow of FIG. 3, upon entering a profile, such as wherein the profile provides a certain set of specific questions based on the user type entered by the user, the inventor may be provided with further questions based on the responses to an initial question set. Thereby, for example, each user employing the interactive engine and entering the user type “inventor,” may be asked to answer the same set of ten questions. Such questions may include, for example, “Please select the category of your invention from the dropdown menu.” Needless to say, interactivity in the present invention may be provided in any manner known in the art, including drop downs, file or folder menus, fill-in-the-blanks, essays, and the like. For example, the interactive engine may provide an active window, such as a questionnaire window, with additional tabs, folders, or the like, across the top or bottom of the page, such as wherein a user can access an alternative tab to leave the questionnaire window and go to the informational window, whereby additional information with regard to a transaction of interest may be provided. Alternatively, a user may be enabled to have multiple active. windows simultaneously, either in an overlay manner or in a parallel, simultaneously on-screen manner, to provide convenient use in gaining multiple information, or providing multiple information, simultaneously.

Upon selection of the category of the invention, the inventor may be asked to enter more specific information, such as in ten words or less, regarding the invention. Such additional specific information my include, for example, the date of conception and/or reduction to practice of invention, whether funding was previously received with regard to the invention and, if so, from whom, what is the amount of investment the inventor is seeking, and other similar questions. Information may additionally include valuation information, type of investors or partners sought, and/or participation in the marketplace of the present invention in accordance with allowing for a non-confidential indication to the marketplace of some or all of the information entered to the profile.

Based on the inventor's responses to the aforementioned preliminary questions in the profile, the user may be preliminarily matched to other users who have asked to be matched with persons providing answers of the type provided by that particular inventor to the preliminary questions. Thereby, an inventor, or any transaction requesting party, may be successively provided with only sufficient information requests to allow for movement to the next level of finding a match. For example, three preliminary matches may request responses to the same 10 questions. The inventor is asked those 10 questions, and only after, for example, 2 of the parties are eliminated based on the responses to the first 10 questions are the 25 additional questions unique to the third prospective match asked of the inventor.

Further, the entity to whom one is matched in accordance with the present invention may be enabled, in accordance with the present invention, to request additional, more specific information, at any stage. For example, once matching occurs, the inventor may be asked additional questions unique to the users with whom that inventor has been matched. Likewise, if a matched party is one of 4 matched parties, that matched party may be provided with enough limited information to formulate additional questions.

Needless to say, the foregoing allows the matched party to be an investor seeking a particular type of match, or a joint venture partner, for example. It further allows for the passage of certain information back to the inventor/user of which the user might not have been initially aware. For example, a micro- (or peer-to-peer) investment group may be one of the interested investing parties, and the inventor may be asked if that is a type of investor acceptable to the inventor before the inventor need respond to information requests from the micro-investment group. Likewise, micro-investors may be treated as singular investors in accordance with the present invention, although it is preferable that any secondary information requested by a micro-investor in such an embodiment be very limited, or be selected from a very limited, standardized form request for secondary information, in part to preclude the inventor from being overwhelmed with information requests that will result in only very small investments toward a larger investment goal.

By way of additional example, a particular investor may be interested in investing in three different categories, and may be interested in investing in only inventions having associated therewith one or more of five particular keywords entered as subcategories to the main category. Further, the particular investor may be interested in investing only in inventions that have already obtained a first round of investment, i.e., the investor may be a venture' capital investor who does not typically invest in a first, early funding round. Further, the investor may be interested only in inventions that do not have government grants associated therewith, because the investor does not wish to be forced to share rights in the invention with the government. Obviously, the investor may be interested in myriad other information that may be associated with the preliminary questions, such as where the inventor is located geographically, the inventor's education and business background, and the like. These and other similar questions may be of unique to each investor, and the investor may wish to not be encumbered by voluminous information extraneous to the unique information of interest to the investor. Thus, the investor may wish to only ask these subsequent questions from an inventor matching the investor's preliminary information needs.

Once an inventor has entered information that meets the investor's preliminary request, the inventor may be asked additional questions of more specific interest to that investor. In such a circumstance, the investor may indicate, in that investor's profile, that the investor is willing to have some, or all, information regarding that investor shared with the inventor, or the investor may wish to remain totally or partially anonymous. Further, it is envisioned in the present invention that multiple investors may have their preliminary requests satisfied by a single inventor, and in such circumstances, for the convenience of the inventor, the prospective investors may remain anonymous automatically, such as to allow their subsequent information requests combined into a. single information request to the inventor. In other words, the investors may have selected, for each investor, twelve to fifteen additional pieces of information that they wish to obtain from inventors in whom they indicate interest based on preliminary responses. Of these twelve to fifteen pieces of information requested by the prospective investors, seven of the pieces of information may overlap. As such, the inventor may be asked those seven questions for all investors, and may separately be asked the five to eight unique questions to each investor, in a single questionnaire format.

For example, an interested investor may wish to seek detailed additional information on an invention in which that investor is interested, but may not wish that information to rise to the level of a business plan. Thus, the investor can design, through the use of the present invention, five detailed questions for the specific technical area of interest to that investor, for example. For example, if the investor is interested in the category “telecommunications,” and is interested in subcategorical keywords such as “cellular,” an inventor who enters invention information in the category “telecommunications,” and includes in the description the word “cellular,” may be referred to that investor as meeting that investor's preliminary information requests. Based on information entered in the investor's profile, the inventor then may be asked, after having met the preliminary information request, a series of subsequent information requests of interest to that investor. For example, in the aforementioned cellular telecommunications example, the inventor may be asked more detailed questions, such as whether the invention relates to CDMA or GSM cellular technology, to attach a 500-word or less detailed description of the invention, to provide an expected market for the invention to be backed up by no more than three pages of attached documentation attached to the inventor's submission, and the like.

Needless to say, information, or templates, with regard to typically requested preliminary information from investors, for example, may be made available to each investor who signs up to the interactive engine. More specifically, for example, an investor may be provided with options to select the ten, fifteen, twenty-five or hundred questions that investors using the interactive engine most often request as the preliminary information from, for example, inventors or universities. The investor may then be enabled to select only those questions that the investor wishes to receive information with regard to, and the investor may further be enabled to select from prepared questions additional information the investor requires, or the investor may be enabled to enter additional questions the investor requires. In any of the aforementioned circumstances, the investor may ask that, to the extent a match is achieved with an inventor, for example, the interactive engine forward only that information requested by the investor. Thereafter, the investor may request to review additional, or all, information available on a party with whom the investor is matched. Thereby, an investor can most efficiently view only the information necessary to that investor for making decisions at each stage of an investment process through the use of the instant invention. It almost goes without saying that, although an investor and an inventor are used by way of example herein, those skilled in the art will appreciate in light of the disclosure herein the applicability of the information monitoring and matching capabilities of the present invention to other parties in transactions for start-up, small, emerging or mid-size company related transactions, including, without limitation, investment, acquisition, co-development, joint venturing, spin-in or spin-out, in-licensing or out-licensing, and the like.

Similarly, the feedback of the present invention may provide guidance to a user type based on successful prior transactions, or failed prior transactions, by similar users of that user type. For example, an investor may receive recommendations based on questions that should be posed to inventors in a certain technical area, because a high percentage of transactions that are subject to those questions at inception are successful.

Additionally, as mentioned hereinabove, the present invention may provide access to service providers, such as legal or accounting advisors. For example, to the extent matched parties wish to engage in a transaction, lawyers, which lawyers may also be members of the interactive engine, may be recommended to participate in the transaction, particularly if the lawyer has participated in a similar transaction as tracked by the feedback returned to the interactive engine of the present invention, and most particularly if the lawyer has participated in a similar transaction with respect to similar matched parties in a prior transaction and has received positive feedback correspondent to that participation.

In fact, the present invention may provide messaging capabilities, such as to send an email to legal counsel, to select available counsel having the most applicable credentials from, for example, a list provided by the interactive engine, and/or to receive contact information for the selected lawyer. Such instant messaging capabilities may allow a desired lawyer to be contacted via, for example, one or more instant messages, such as SMS, MMS, facsimile, email, instant messaging, or the like, when one or more parties in a transaction indicate the desire to work with that particular counsel.

Likewise, the interactive engine may enable the maintenance of documentation from prior transactions occurring between matched parties, such as in a database communicatively connected to the engine. Of course, such transaction documentation may be made available to any parties making use of the interactive engine, or only to particular types of parties, such as only to other lawyers who are members of the interactive engine. Of course, although legal advice is used by way of example hereinabove, the present invention is equally applicable to other types of service providers who may become members and/or participants in the interactive engine environment. For example, accounting services may be recommended from among accountant members of the interactive engine environment, and/or from among accountants who have previously provided accounting services for investment transactions occurring via the interactive engine, and/or from among accountants who have received positive feedback in the course of providing services through the interactive engine environment.

Similarly, the present invention may provide, via the interface of the interactive engine, information uniquely relevant to the type of party logged onto the interactive engine. Additionally and alternatively, for example, certain information may be made available from the interactive engine to all parties, to all parties who are members of the interactive engine, only to parties of a certain type within the interactive engine, or only to parties with whom information is desired to be shared by another party who is a member of the interactive engine environment. For example, inventors or universities who are members of the interactive group may wish to obtain information regarding gaining investment, or in joint venturing to spin-out new companies with other technologists, researchers, or investors. Such information may be made available to any inventor who states, as an area of interest, gaining investment, and such information may include information culled from web searching, such as a spider crawl, information deemed by other members of the site to be of particular use in prior transactions, information deemed by acknowledged experts in the field to be particularly useful, or the like.

Information provided unique to each party may be modified at various stages of a transaction. For example, a university may be provided with a first set of information accessible to universities seeking to joint venture to spin-out a university technology. Once the university looking for a joint venture partner responds with information that makes that university of interest, as a partner, to an investor, that university member may then be granted access to information uniquely provided by that investor, such as press releases with regard to that investor, articles published by that investor, or the like. Such information may be provided automatically when the investor expresses interest in the university, or may be provided by a file sharing only with permission from the investor, for example.

Those skilled in the art will appreciate, in light of the discussion herein, that the present invention may make numerous e-commerce models available to the members of the interactive engine, and to the provider of the interactive engine. For example, advertisements may be provided on the website providing the interactive engine, and those advertisements may be of particular interest to the then-current user of the interactive engine, based on, for example, cookies or profile information that has been provided by the active user. On the other hand, the present invention may provide no advertisements, at least in that the present invention may be modeled to give only that information that is most relevant and helpful to any member of the interactive engine, and thus may impress upon users that advertisements are not used in conjunction with the site. Alternatively, advertisements may be provided only upon certain occurrences in the user interface, such as upon offering of a transaction between matched parties.

In an exemplary embodiment, and as referenced hereinabove, certain user types may “sponsor” the engine of the present invention, and thereby obtain premium advertising space and/or return as a priority match or referral for transaction requestors. Yet further, the present invention allows for tracking of numbers of members, patent applications filed through referral links, patents issued to users, in transactions, or through referral links, number of specific types of users, such as sole inventors or investors, numbers of transactions achieved, and the like. The tracking of this information allows for the use of the information in advertising, such as by the engine of the present invention and/or by third parties.

In the event of a transaction offer between matched parties, the interactive engine may provide a fulfillment interface. The fulfillment interface may contain an offer for a transaction, a term sheet for a transaction, documentation for a transaction, contact information to put an attorney on one side of a transaction in touch with an attorney from another side of a transaction, or the like, for example. Thereby, the fulfillment interface may include fulfillment of the match in the form of an offer, or may detail a transaction, such as using recommended templates and/or suggested terms, through to completion of the entire transaction.

Numerous e-commerce models may be provided in accordance with the fulfillment interface. More particularly, the initial party requesting a match, such as an inventor or university requesting a partner or investor, may be asked to pay a fee, such as upon initiation of an offer between the matched parties, or may be asked to pay a percentage of funds obtained in a transaction, such as in the range of about 0-5% of funds obtained by a borrower/investee, in the event of fulfillment of the entire transaction. Similarly, independently or in conjunction with fees paid by a borrower/investee, a user will contribute equity in the newly formed company, invention, or the like, to the facilitators of the transaction, that is, to the providers of the engine of the present invention. On the other hand, the lender/investor may be asked to pay a percentage, such as about 0.1-3%, of funds invested.

Alternatively, members may be asked to pay particular fees upon joining the interactive engine environment. In such an embodiment, it may be preferable that only certain parties be asked to pay a membership fee, such as investors seeking parties for investment, and that other parties be asked to pay fees only in association with fulfillment of a transaction, which may particularly be the case for independent investors seeking a matched party, for example.

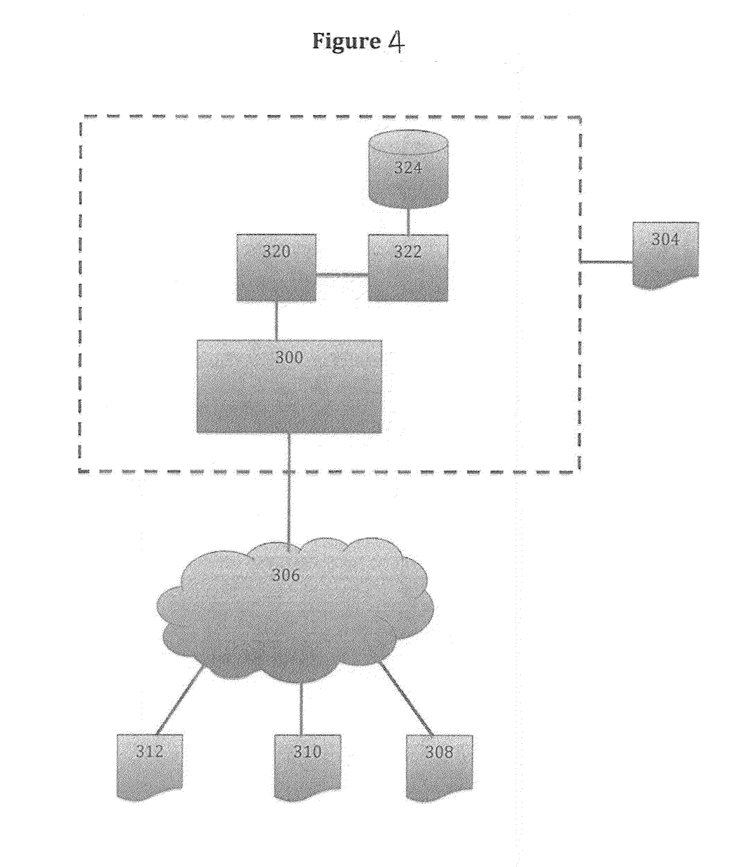

FIG. 4 is a block diagram illustrating a networked embodiment of the present invention. As illustrated, a provider 304 may provide the interactive interconnecting engine 300, such as in the form of a thin client, over network 306 to a plurality of users 308, 310, 312 of various user types and correspondent to any of a variety of user devices capable of receiving the networked communications provided over network 306. The engine 300 so provided may preferably be computing software embodied in computing code for execution by one or more computing processors 320, and associated with one or more computing memories 322. Communicatively connected to the memories 322 may be one or more databases 324 for storing information associated with the engine 300, such as feedback of prior transactions, documents used in prior transactions, and the like.

Although the disclosure has been described and pictured in an exemplary form with a certain degree of particularity, it is understood that the present disclosure has been made by way of example, and that numerous changes in the details of construction and combination and arrangement of parts and steps may be made without departing from the spirit and scope of the disclosure as set forth and of the claims hereinafter.

What is claimed is:

1. A method for providing an interactive interconnection engine, executed as computing code resident in at least one computing memory via at least one computing processor, comprising:
requesting remote entry over at least one network to a port of the interactive interconnection engine of at least one profile from each of at least two users, wherein the profile comprises at least a user type, a technology type, and a transaction sought;
electronically querying over the at least one network of each of the at least two users with at least one preliminary profile question indicated by the profile;
preliminarily matching using at least one relational database communicatively associated with the computing processor of at least two of the at least two users in a transaction indicated by at least the profile and the preliminary profile questions;
electronically providing at least a first of the at least two users with secondary questions from the other of the at least two users, responsive to said preliminarily matching and indicated by the transaction sought;
interconnecting the at least two users in accordance with responses received to the secondary questions; and
remotely fulfilling the transaction sought after said interconnecting.

2. The method of claim 1, wherein the transaction is one selected from the group consisting of investment, acquisition, spin-in, spin-out, license-in, license-out, joint venture, and co-development.

3. The method of claim 1, wherein said electronically providing comprises assessing a quality of said preliminary matching based on responses received to the secondary questions.

4. The method of claim 1, wherein said fulfilling comprises linking to service providers.

5. The method of claim 1, wherein said fulfilling comprises linking to fulfillment documents.

6. The method of claim 1, wherein said fulfilling comprises providing educational materials.

7. The method of claim 6, wherein the educational material is unique to each of the at least two users.

8. The method of claim 1, wherein the other of the two users comprises an investment entity.

9. The method of claim 1, wherein the investment entity comprises at least one micro-investor.

10. The method of claim 1, wherein said remotely fulfilling comprises legally binding at least one of the at least two users to pay a third party within a predetermined timeframe.
